(19) United States
(12) Patent Application Publication
(10) Pub. No.: US 2025/0350662 A1
(43) Pub. Date: Nov. 13, 2025

(54) METHOD AND APPARATUS FOR TRANSMITTING COMMAND MESSAGE IN WIRELESS COMMUNICATION SYSTEM

(71) Applicant: Samsung Electronics Co., Ltd., Suwon-si (KR)

(72) Inventors: Sangyeob JUNG, Suwon-si (KR); Weiping SUN, Suwon-si (KR)

(21) Appl. No.: 19/203,982

(22) Filed: May 9, 2025

(30) Foreign Application Priority Data
May 9, 2024 (KR) 10-2024-0061294

(51) Int. Cl. H04L 67/12; G16Y 10/75; G16Y 40/30

(52) U.S. Cl. CPC H04L 67/12; G16Y 10/75; G16Y 40/30

(57) ABSTRACT

The disclosure relates to a 5G or 6G communication system for supporting a higher data transmission rate. A method performed by an ambient internet of things (IoT) (A-IoT) device in a wireless communication system is provided. The method includes receiving, from a reader, a command message and transmitting, to the reader, at least one of segments of a command response message, wherein each of the at least one of the segments includes information indicating whether a segment including the information is a last segment or not.

### CROSS-REFERENCE TO RELATED APPLICATION(S)

This application is based on and claims priority under 35 U.S.C. § 119 (a) of a Korean patent application number 10-2024-0061294, filed on May 9, 2024, in the Korean Intellectual Property Office, the disclosure of which is incorporated by reference herein in its entirety.

### BACKGROUND

### 1. Field

The disclosure relates to a method and apparatus for transmitting a command message in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for transmitting a command message in a wireless communication system.

Additional aspects will be set forth in part in the description which follows and, in part, will be apparent from the description, or may be learned by practice of the presented embodiments.

In accordance with an aspect of the disclosure, a method performed by an ambient internet of things (IoT) (A-IoT) device in a wireless communication system is provided. The method includes receiving, from a reader, a command message and transmitting, to the reader, at least one of segments of a command response message, wherein each of the at least one of the segments includes information indicating whether a segment including the information is a last segment or not.

In accordance with another aspect of the disclosure, a method performed by a reader in a wireless communication system is provided. The method includes transmitting, to an ambient internet of things (IoT) (A-IoT) device, a command message and receiving, from the A-IoT device, at least one of segments of a command response message, wherein each of the at least one of the segments includes information indicating whether a segment including the information is a last segment or not.

In accordance with another aspect of the disclosure, an ambient internet of things (IoT) (A-IoT) device in a wireless communication system is provided. The A-IoT device includes a transceiver and a controller coupled with the transceiver and configured to receive, from a reader, a command message, and transmit, to the reader, at least one of segments of a command response message, wherein each of the at least one of the segments includes information indicating whether a segment including the information is a last segment or not.

In accordance with another aspect of the disclosure, a reader in a wireless communication system is provided. The reader includes a transceiver and a controller coupled with the transceiver and configured to transmit, to an ambient internet of things (IoT) (A-IoT) device, a command message, and receive, from the A-IoT device, at least one of segments of a command response message, wherein each of the at least one of the segments includes information indicating whether a segment including the information is a last segment or not.

According to an embodiment of the disclosure, an apparatus and a method capable of effectively providing services in a mobile communication system are provided.

According to an embodiment of the disclosure, an apparatus and a method capable of effectively providing services in a wireless communication system can be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a structure of a next-generation mobile communication system according to an embodiment of the disclosure;

FIG. 1B illustrates a radio protocol structure of a next-generation mobile communication system according to an embodiment of the disclosure;

FIG. 1C is a view illustrating a topology and deployment scenario in which Ambient Internet of Things (IoT) communication is supported in a next generation mobile communication system according to an embodiment of the disclosure;

FIG. 1D is a view illustrating a use case in which Ambient IoT communication is supported in a next generation mobile communication system according to an embodiment of the disclosure;

FIG. 1E is a view illustrating a procedure to inventory all Ambient IoT devices in a next generation mobile communication system according to an embodiment of the disclosure;

FIG. 1F is a flowchart illustrating an Ambient IoT device receiving a segmented command message and responding thereto according to an embodiment of the disclosure;

FIG. 1G is a flowchart illustrating an Ambient IoT device receiving a segmented command message and responding thereto according to an embodiment of the disclosure;

FIG. 1H is a flowchart illustrating an Ambient IoT device receiving a segmented command message and responding thereto according to an embodiment of the disclosure;

FIG. 1I is a flowchart illustrating an Ambient IoT device receiving a segmented command message and responding thereto according to an embodiment of the disclosure;

FIG. 1J is a flowchart illustrating an Ambient IoT device receiving a segmented command message and responding thereto according to an embodiment of the disclosure;

FIG. 1K is a block diagram illustrating an internal structure of a UE according to an embodiment of the disclosure;

FIG. 1L is a block diagram illustrating a structure of a new radio (NR) base station according to an embodiment of the disclosure; and

FIG. 1M illustrates a structure of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the disclosure below, a detailed description of known functions or configurations will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or LTE-advanced (LTE-A) systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the disclosure may be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, terms and names defined in the 3rd generation partnership project long term evolution (3GPP LTE) and/or 5G standards will be used for the sake of descriptive convenience. However, the disclosure is not limited by the terms and names of the 3GPP LTE and/or 5G standards, and may be applied in the same way to systems that conform other standards. In the disclosure, the term “eNB” may be interchangeably used with the term “gNB” for the sake of descriptive convenience. That is, a base station described as “eNB” may refer to “gNB”.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

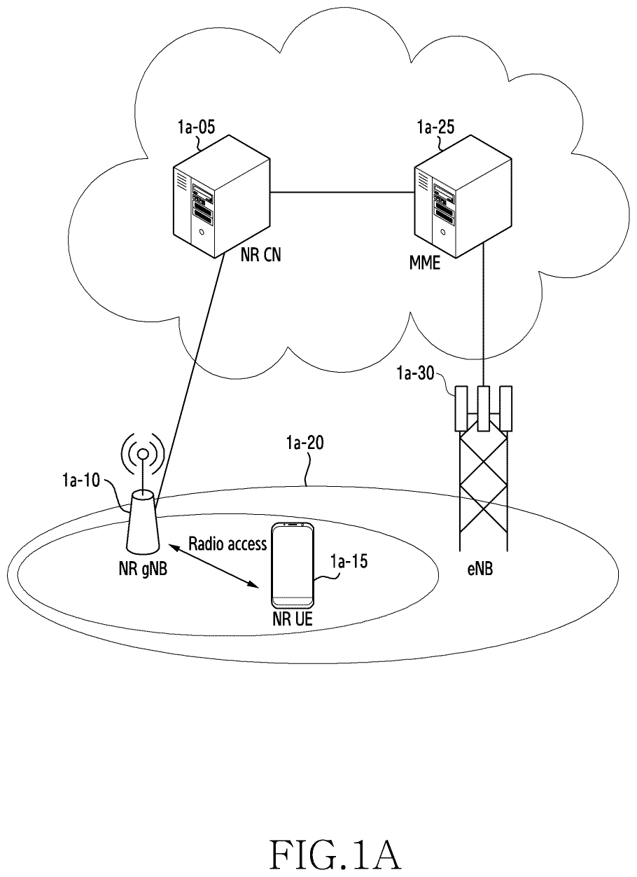

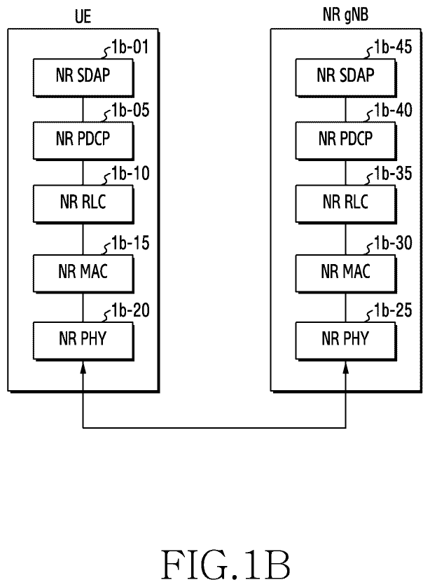

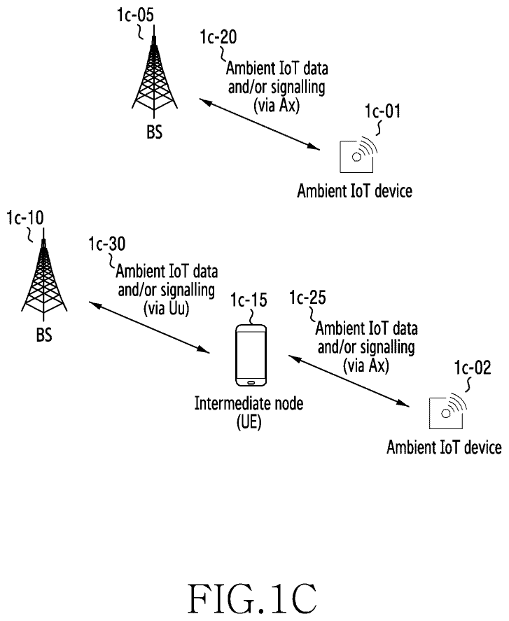

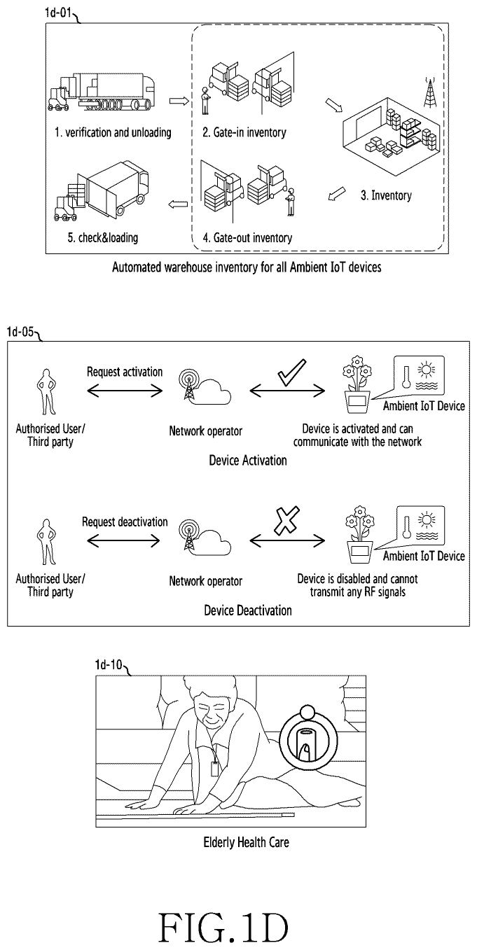

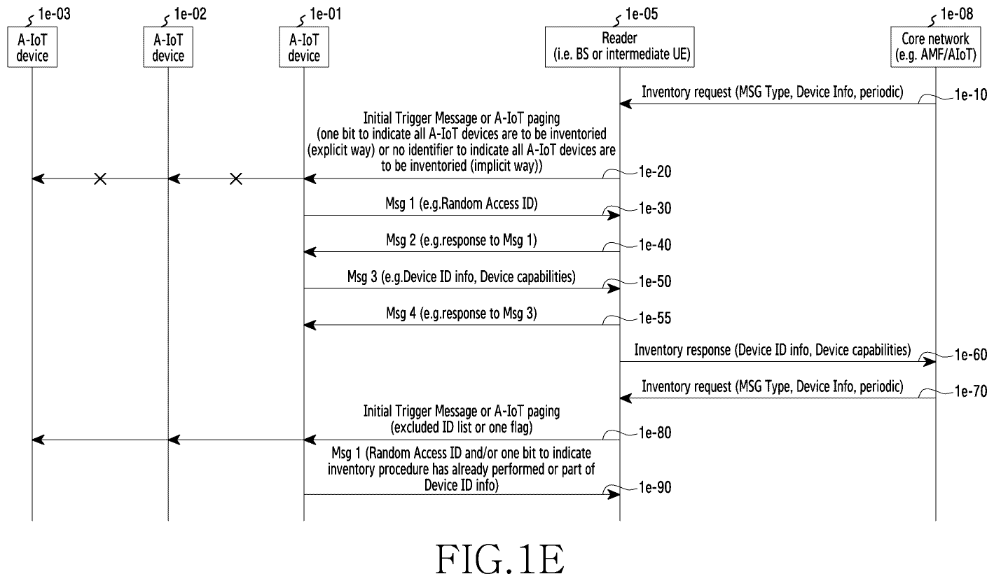

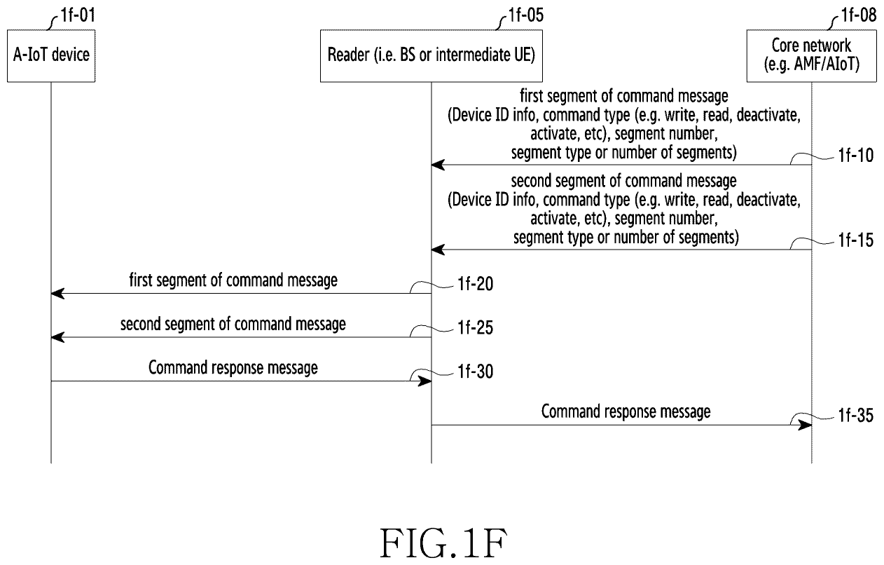

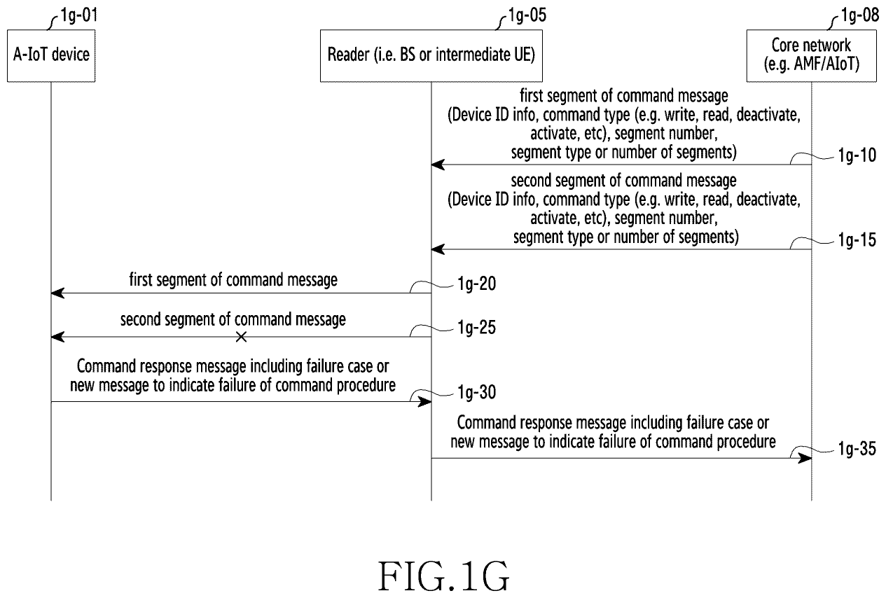

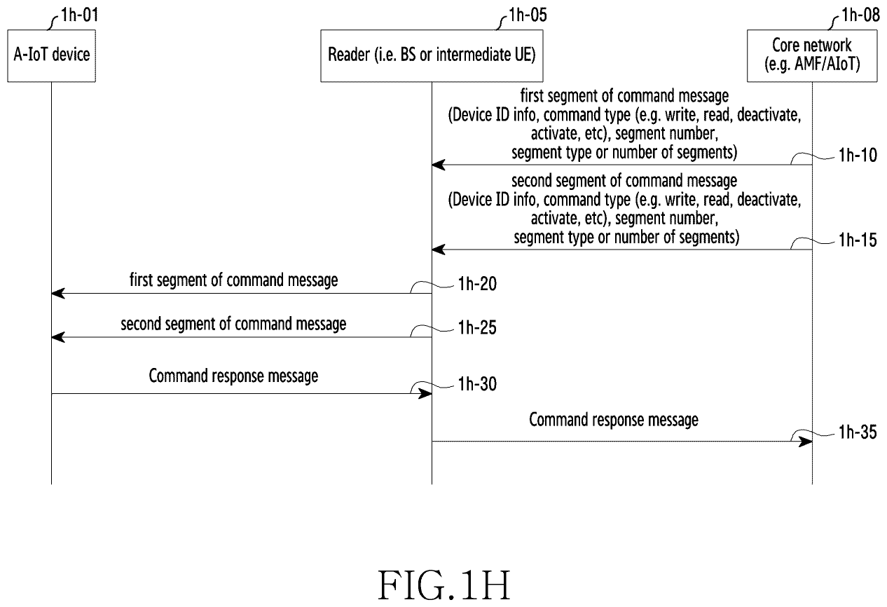

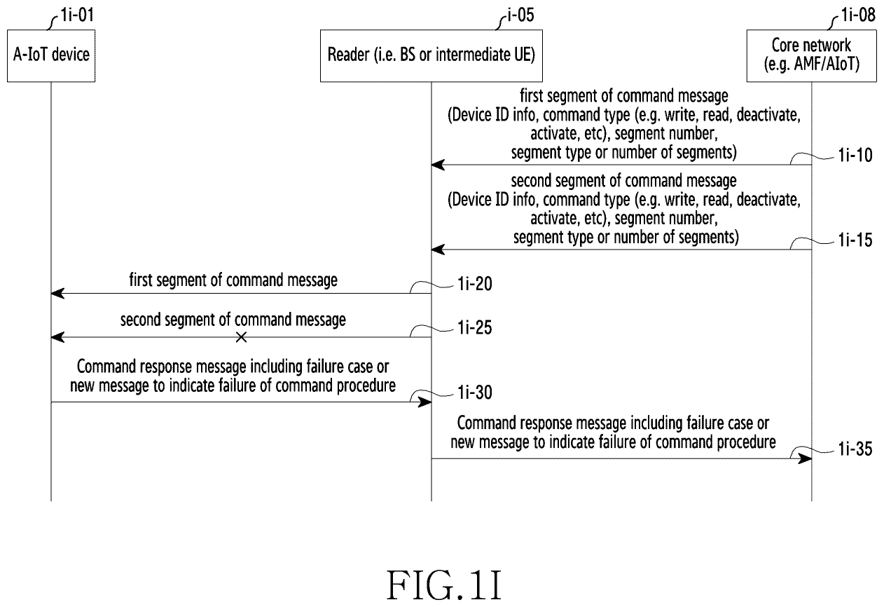

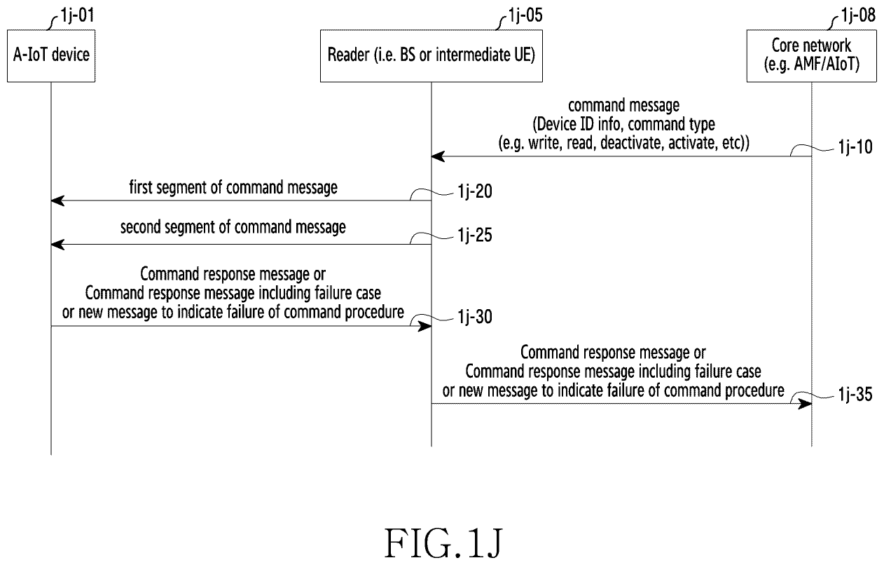

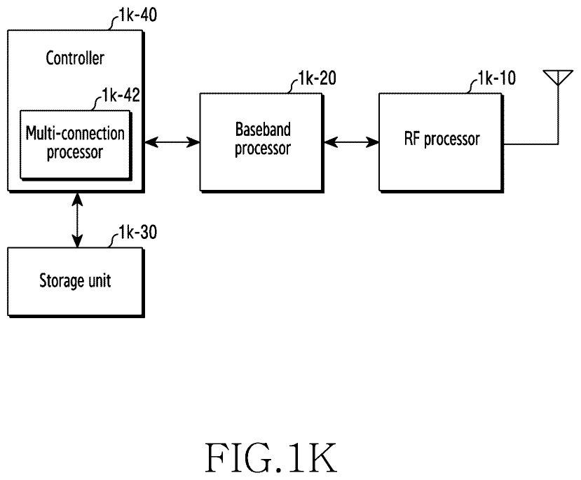

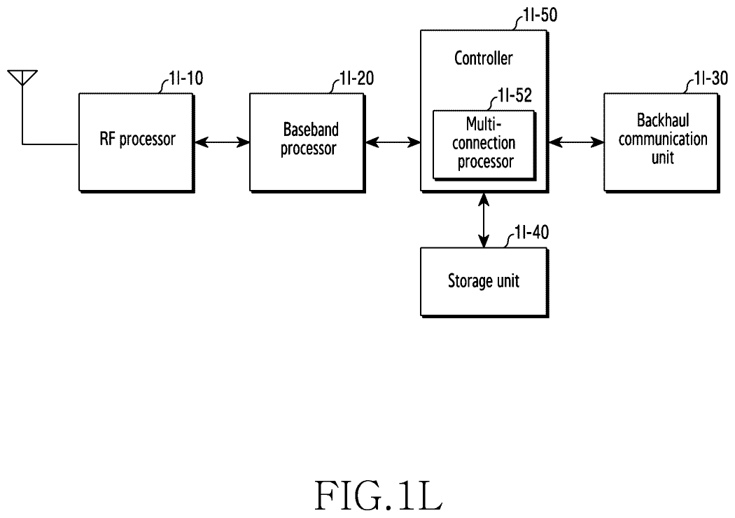

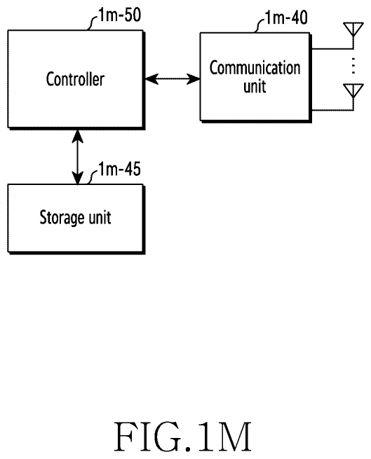

FIG. 1A illustrates a structure of a next-generation mobile communication system according to an embodiment of the disclosure.

Referring to FIG. 1A, a radio access network of a next-generation mobile communication system (hereinafter NR or 5G) includes a next-generation base station (new radio node B, hereinafter NR gNB or NR base station) 1a-10, and a new radio core network (NR CN) 1a-05. A user terminal (new radio user equipment, hereinafter NR UE or NR terminal) 1a-15 accesses an external network via the NR gNB 1a-10 and the NR CN 1a-05.

Referring to FIG. 1A, the NR gNB 1a-10 corresponds to an evolved node B (eNB) of a conventional LTE system. The NR gNB is connected to the NR UE 1a-15 through a radio channel, and can provide outstanding services as compared to a conventional node B. In the next-generation mobile communication system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the NR gNB 1a-10 serves as the device. In general, one NR gNB controls multiple cells (e.g., cell 1a-20). In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The NR CN 1a-05 performs functions such as mobility support, bearer configuration, and QoS configuration. The NR CN is a device responsible for various control functions as well as a mobility management function for a UE, and is connected to multiple base stations. In addition, the next-generation mobile communication system may interwork with the existing LTE system, and the NR CN is connected to a mobility management entity (MME) 1a-25 via a network interface. The MME is connected to an eNB 1a-30 that is an existing base station.

FIG. 1B illustrates a radio protocol structure of a next-generation mobile communication system according to an embodiment of the disclosure.

Referring to FIG. 1B, a radio protocol of a next-generation mobile communication system includes an NR SDAP 1b-01 or 1b-45, an NR PDCP 1b-05 or 1b-40, an NR RLC 1b-10 or 1b-35, and an NR medium access control (MAC) 1b-15 or 1b-30 on each of UE and NR gNB sides.

The main functions of the NR SDAP 1b-01 or 1b-45 may include some of functions below.
Transfer of user plane data
Mapping between a quality of service (QOS) flow and a data radio bearer (DRB) for both downlink (DL) and uplink (UL)
Marking QoS flow ID in both DL and UL packets
Reflective QoS flow to DRB mapping for UL service data adaptation protocol (SDAP) protocol data units (PDUs)

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (non access stratum (NAS) reflective QoS) and the AS QoS reflection configuration 1-bit indicator (AS reflective QoS) of the SDAP header may be indicated so that the UE can update or reconfigure mapping information on the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1b-05 or 1b-40 may include some of functions below.
Header compression and decompression: Robust Header Compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 1b-10 or 1b-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
Radio link control (RLC) SDU discard
RLC re-establishment

The in-sequence delivery of the NR RLC device refers to a function of delivering RLC service data units (SDUs), received from the lower layer, to the upper layer in sequence, may include a function of reassembling and delivering multiple RLC SDUs received, into which one original RLC SDU has been segmented, may include a function of reordering the received RLC protocol data units (PDUs) with reference to the RLC sequence number (SN) or PDCP sequence number (SN), may include a function of recording RLC PDUs lost as a result of reordering, may include a function of reporting the state of the lost RLC PDUs to the transmitting side, may include a function of requesting retransmission of the lost RLC PDUs, may include a function of, if there is a lost RLC SDU, successively delivering only RLC SDUs before the lost RLC SDU to the upper layer, may include a function of, if a predetermined timer has expired although there is a lost RLC SDU, successively delivering all RLC SDUs received before the timer was started to the upper layer. or may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 1b-15 or 1b-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
Multimedia Broadcast Multicast Service (MBMS) service identification
Transport format selection
Padding

An NR PHY layer 1b-20 or 1b-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1C illustrates a topology and deployment scenario in which Ambient Internet of Things (IoT) communication is supported in a next generation mobile communication system according to an embodiment of the disclosure.

Referring to FIG. 1C, the Ambient IoT device 1c-01 or 1c-02 according to an embodiment is an apparatus having very low maximum power consumption and may support about 1 uW peak power consumption maximum, or about several hundred uW peak power consumption. For example, the Ambient IoT device may perform uplink transmission basically through backscattering. That is, the Ambient IoT device may perform uplink transmission by using an external carrier wave.

For example, in case of uplink transmission, the Ambient IoT device may perform amplification. However, the disclosure is not limited thereto, and the Ambient IoT device may not perform amplification. For another example, the Ambient IoT device may internally generate a carrier wave for uplink transmission.

For example, the Ambient IoT device have no radio resource control (RRC) state and may not support mobility such as cell selection or cell reselection. In addition, the Ambient IoT device is a low-spec device not supporting Hybrid Automatic Repeat and reQuest (HARQ) and Automatic Repeat reQuest (ARQ).

The term Ambient IoT device in the disclosure is for illustrative purposes only. For example, the term Ambient IoT device may be replaced by the terms Redcap (reduced capability) UE, NR-light UE, low specification UE, low capability UE, low power device, energy saving device, and/or peripheral device.

According to an embodiment, the Ambient IoT device 1c-01 or 1c-02 may be referred to as a advice which uses energy harvesting to use or acquire power, does not have a battery, or may have limited energy storage capabilities. However, this is only an example, and the disclosure is not limited thereto.

According to an embodiment, the Ambient IoT device 1c-01 may perform bi-directional communication directly with a base station 1c-05. That is, the Ambient IoT device 1c-01 may transmit and/or receive (1c-20) Ambient IoT data and/or signaling to and/or from the base station 1c-05 (e.g., gNB and/or eNB). For example, the Ambient IoT device 1c-01 may transmit and/or receive data, a control signal, an RRC message, and/or the like to and/or from the base station.

For example, the Ambient IoT device 1c-01 may transmit (or, receive) Ambient IoT data and/or signaling to (or, from) the base station 1c-05 and receive (or, transmit) Ambient IoT data and/or signaling to (or, from) another base station 1c-10. For example, the Ambient IoT device 1c-01 may be located indoors and the base station 1c-05 or 1c-10 may be located indoors. For another example, the base station 1c-05 may be located indoors, and the base station 1c-10 may be located outdoors.

According to an embodiment, communication may be supported through a new interface rather than through a Uu interface between the conventional UE and the base station. In the disclosure, the new interface may be referred to as an Ax interface. However, this is only an example, and the communication between the Ambient IoT device and the base station may use the Uu interface.

According to an embodiment, the Ambient IoT device 1c-02 may perform bidirectional communication with a UE 1c-15 operating as an intermediate node through the Ax interface and accordingly, the UE 1c-15 operating as the intermediate node may perform bidirectional communication with the base station 1c-01 through the Uu interface. That is, the Ambient IoT device 1c-02 may transmit and/or receive (1c-25) Ambient IoT data and/or signaling to and/or from the UE 1c-15 operating as the intermediate node. The UE 1c-15 corresponding to the intermediate node may transmit or receive (1c-30) Ambient IoT data and/or signaling to or from the base station 1c-10.

The intermediate node of the disclosure may be referred to by various terms. For example, the intermediate node may be referred to as a relay node, relay UE, relay device, or relay device.

For example, the device 1c-02 and the UE 1c-15 operating as the intermediate node may be located indoors, and the base station 1c-10 may be located outdoors.

FIG. 1D is a view illustrating a use case in which Ambient IoT communication is supported in a next generation mobile communication system according to an embodiment of the disclosure.

Referring to FIG. 1D, the mobile communication system according to an embodiment may provide a service targeting a designated Ambient IoT device (1d-10), may provide a service targeting a group Ambient IoT device including two or more Ambient IoT devices (1d-05), or may provide a service targeting all Ambient IoT devices (1d-01). For example, the mobile communication system may provide a service to the Ambient IoT device based on a unicast method, may provide a service to the Ambient IoT device based on a multicast method, and may provide a service to the Ambient IoT device based on a broadcast method.

According to an embodiment, a first scenario 1d-01 is related to a scenario for an automated warehouse inventory. In the scenario, various warehouse storage management information (warehousing information) may be generated for transferring of goods, storage of goods, and/or inventory of goods. Specifically, the scenario may be structured in five steps. The steps in the scenario are only examples, and other steps may be added or at least some of the steps in the scenario may be omitted.
Operation 1: Verify and unload goods (verification and unloading of goods)
Operation 2: Move goods into a gate (gate-in inventory)
Operation 3: Manage inventory (inventory)
Operation 4: Move goods out of a gate (gate-in inventory)
Operation 5: Check and load goods (check & loading)

In the scenario, for automated warehouse inventory, an item-specific Ambient IoT device may be attached, and an inventory procedure may be performed with respect to all Ambient IoT devices and a command procedure to write and read features of goods may be performed. Accordingly, efficient warehouse inventory management is possible.

According to an embodiment, the second scenario 1d-05 relates to a scenario for sensing the surrounding environment through an Ambient IoT device. In the scenario, when an orchid is planted, an Ambient IoT device may be attached to the orchid, and the mobile communication system may use the Ambient IoT device to monitor the surrounding environment of the plant and provide generated monitoring information to authorized users and third parties.

In the second scenario, an inventory procedure may be performed on Ambient IoT devices (e.g., a group of Ambient IoT devices) attached to multiple plants, and a command procedure may be performed to activate or deactivate each Ambient IoT device so that the plants may be managed efficiently.

According to an embodiment, the third scenario 1d-10 relates to a scenario of managing the health of seniors through an Ambient IoT device. In the scenario, the health condition of seniors with heart disease or chronic conditions may be continuously monitored, and the generated monitoring information may be periodically provided to authorized users (e.g., doctors).

In the third scenario, an inventory procedure may be performed on an Ambient IoT device attached to a specific senior and a command procedure, which is a procedure for reading information required for a specific Ambient IoT device, may be performed to efficiently manage the senior's health condition.

FIG. 1E is a view illustrating a procedure to inventory all Ambient Internet of Things (IoT) devices in a next generation mobile communication system according to an embodiment of the disclosure.

Referring to FIG. 1E, the core network (hereinafter, CN 1e-08) according to an embodiment may initiate the inventory procedure by transferring (1e-10) an inventory request message to a Reader 1e-05 to identify all Ambient IoT (A-IoT) devices 1e-01, 1e-02, and 1e-03 or to reach all A-IoT devices 1e-01, 1e-02, and 1e-03. For example, the CN 1e-08 may be referenced as an Access and Mobility Management Function (AMF) entity for supporting Ambient IoT communication. For example, the CN 1e-08 may be referenced as a designated entity within the core network supporting Ambient IoT. For example, the inventory request message (e.g., N2′ message) may include at least a portion of the following information.
Information indicating a message type: information for distinguishing whether a message is an inventory request message or a command message
Device information: indicator for requesting to perform an inventory procedure on all A-IoT devices (or device information may not include a separate A-IoT device identifier. That is, a separate Identifier or ID needs to be included to indicate to initiate the inventory procedure for one or more A-IoT devices, but by not including the Identifier or Id, it is possible to indicate to perform the inventory procedure for all A-IoT devices.)

Period information: information for periodically transmitting an inventory request message, or information for one-shot transmission, or information for non-periodic transmission. For example, the period information may include information about a period (or, a cycle) of inventory request messages, an offset between periods, and/or the number of repetitions.

According to an embodiment, in operation 1e-20, the Reader (or, reader device) 1e-05 having received the inventory request message may broadcast an Initial Trigger Message (or, A-IoT Paging) with respect to all A-IoT devices 1e-01, 1e-02, and 1e-03. For example, the Reader 1e-05 may be referenced as a User Equipment (hereinafter, UE) or a base station (hereinafter, BS) supporting the Ambient IoT communication. For example, the initial trigger message (or A-IoT Paging) may include at least one of information included in the inventory request message having received in operation 1e-10. For example, device information may be included in the Initial Trigger Message (or, A-IoT Paging).

For example, the initial trigger message (or A-IoT Paging) may include at least a portion of the following information.
Frequency shift or frequency channel information (e.g., frequency information)
Information of parameters required to perform slotted aloha random access:

### Access Probability Information

### Access Time Point Information (e.g., Time Information)

For example, slotted aloha may be referenced as a wireless communication protocol that performs synchronization between users to prevent data conflicts between devices or users. For example, in slotted Aloha, conflicts may be minimized by transmitting data only at the beginning of the time-slot.

According to an embodiment, in operation 1e-30, a predetermined A-IoT device 1e-01 having successfully received the initial trigger message (or A-IoT Paging) may transmit message 1 (e.g., Msg1) (e.g., a random-access preamble) to the Reader 1e-05 to perform random access to the Reader 1e-05 by using a slotted aloha protocol. For example, Msg 1 may represent a message including a Random Access identity (ID) through a specific frequency. For example, Msg 1 may correspond to a message including a Random Access ID of the A-IoT device 1e-01.

According to an embodiment, in operation 1e-40, the Reader 1e-05 may transmit a response message (e.g., message 2 or Msg 2) (e.g., random access response) for indicating that Msg 1 has been successfully received to the A-IoT device 1e-01. The A-IoT device 1e-01 may store information indicating that the inventory procedure or the random-access procedure has been successfully performed in the memory. In this case, even if an Initial Trigger Message (or A-IoT Paging) is later received for an A-IoT device, the A-IoT device may not initiate a random-access procedure.

According to an embodiment, in operation 1e-50, the A-IoT device 1e-01 may transmit message 3 Msg 3 to provide additional device information to the Reader 1e-05. For example, Msg 3 may include at least a portion of the following information.

### Device ID Information for Additionally Identifying A-IoT Devices (e.g., Identification Information of A-IoT Devices)

A-IoT device capability information

### Capability Information on Whether a Higher Layer Device of an A-IoT Device Supports Segmented Messages

Capability Information on Whether an Access Stratum (AS) Layer Device of an a-IoT Device Supports Segmented Messages

According to an embodiment, the A-IoT device 1e-01 may store information (or, state) indicating that the inventory procedure or the random-access procedure has been successfully performed in the memory. In this case, even if an initial trigger message (or A-IoT Paging) is later received for an A-IoT device, the A-IoT device may not initiate a random-access procedure.

According to an embodiment, in operation 1e-55, the Reader 1e-05 may transmit a response message to the A-IoT device 1e-01 so as to indicate that Msg 3 has been successfully received. The A-IoT device 1e-01 may store information (or state) indicating that the inventory procedure and/or the random-access procedure has been successfully performed in the memory. In this case, even if an Initial Trigger Message (or A-IoT Paging) is later received for an A-IoT device, the random-access procedure may not be initiated.

However, this is only an example, and the step of transmitting the response message may be omitted.

According to an embodiment, in operation 1e-60, the Reader 1e-05 may transfer the message received from the A-IoT device 1e-01 to the CN 1e-08. For example, the message may correspond to N2′ message and may be referenced as an inventory response message.

In the disclosure, the inventory procedure is initiated on all A-IoT devices 1e-01, 1e-02, and 1e-03, but the inventory procedure may be successfully performed on a predetermined A-IoT device 1e-01. Accordingly, the inventory procedure may be initiated on remaining A-IoT devices 1e-02 and 1e-03 excluding the A-IoT device 1e-01 having successfully performed the inventory procedure.

According to an embodiment, in operation 1e-70, the core network (hereinafter, CN 1e-08) may initiate the inventory procedure by transferring (1e-70) an inventory request message to the Reader 1e-05 to identify all Ambient IoT (A-IoT) devices 1e-02 and 1e-03 excluding the A-IoT device 1e-01 having successfully performed the inventory procedure or to reach all Ambient IoT (A-IoT) devices 1e-02 and 1e-03 excluding the A-IoT device 1e-01 having successfully performed the inventory procedure. In the disclosure, the inventory request message may include at least a portion of the following information.
Information indicating a message type: information (or indicator) for distinguishing whether a message is an inventory request message or a command message
Device information: device information for indicating to perform an inventory procedure on all A-IoT devices excluding the A-IoT device 1e-01 may include at least a portion of the following.
   Information or List of a-IoT Devices to be Excluded

For example, an identifier (Device ID or Random Access ID) for identifying the A-IoT device 1e-01

An identifier indicating the A-IoT device(s) that successfully performed the inventory procedure not to perform the inventory procedure separately
Period information: information (e.g., cycle information, offset information, or information about the number of repetitions) for periodically transmitting an inventory request message, or information for one-shot transmission, or information for non-periodic transmission

According to an embodiment, in operation 1e-80, the Reader 1e-05 having received the inventory request message may broadcast an Initial Trigger Message (or A-IoT Paging) for all Ambient IoT (A-IoT) devices 1e-02 and 1e-03 excluding the A-IoT device 1e-01 having successfully performed the inventory procedure. For example, the Initial Trigger Message (or A-IoT Paging) may include at least a portion of information included in the inventory request message having received in operations 1e-70 or 1e-10. For example, device information may be included in the Initial Trigger Message (or A-IoT Paging). Of course, the Initial Trigger Message may also be generated and broadcast separately by the Reader based on the information received in operation 1e-10. Here, the message may include at least a portion of the following information.
Device information: device information for indicating to perform an inventory procedure on all A-IoT devices excluding the A-IoT device 1e-01 may include at least a portion of the following.

Information or list of an A-IoT device to be excluded (e.g., information or list of an A-IoT device having successfully performed the procedure)

For example, an identifier (Device ID or Random Access ID) for identifying the A-IoT device 1e-01 (e.g., an ID of an A-IoT device subject to the inventory procedure and/or an ID of an A-IoT subject to exclusion)

An identifier indicating the A-IoT device(s) that successfully performed the inventory procedure not to perform the inventory procedure separately

Thereafter, the Ambient IoT (A-IoT) devices 1e-02 and 1e-03 may perform the inventory procedure according to the aforementioned steps. For example, the devices may transmit message 1 by using a Random Access ID other than the Random Access ID used by the Ambient IoT device 1e-01. That is, the Random Access ID may be reissued.

According to an embodiment, in operation 1e-90, the Ambient IoT device 1e-01 may transmit message 1 (Msg1) to the Reader 1e-05 to perform random access to the Reader 1e-05 by using a slotted aloha protocol. Here, the device according to the disclosure may transmit a message including a portion of the Random Access ID used in operation 1e-30 and/or the indicator indicating that the inventory procedure has been successfully performed and/or the Device ID used in operation 1e-50. However, it is merely an example and the A-IoT device 1e-01, in case that information (or, state) indicating that the inventory procedure and/or the random-access procedure has been successfully performed is stored in the memory, may not separately initiate the random-access procedure.

FIG. 1F is a flowchart illustrating an Ambient IoT device receiving a segmented command message and responding thereto according to an embodiment of the disclosure.

Referring to FIG. 1F, the mobile communication system (or the core network) may perform the command procedure with a specific Ambient IoT (A-IoT) device having successfully performed the inventory procedure according to the embodiment described above. For example, the core network may transmit a command message that is segmented according to a capability of the A-IoT device through the Reader. That is, in case that a size of the information to be provided through the command message is larger than a size of the information that may be included in a single command message, the core network may segment the information to be provided through the command message and transmit a plurality of segmented command messages to the A-IoT device through the Reader.

Referring to FIG. 1F, according to the embodiment described above, a predetermined Ambient IoT (A-IoT) device 1f-01 may correspond to a device having successfully performed the inventory procedure.

According to an embodiment, in operations 1f-10 and 1f-15, the core network (hereinafter, CN 1f-08) may transmit a plurality of segmented command messages (segment of command message) to the Reader 1f-05 to transmit or receive Ambient IoT data to or from the A-IoT device 1f-01. For ease of illustration, two segmented command messages are assumed in this disclosure. However, the number of segmented command messages (e.g., 2) is just an example, and command messages may be segmented by any number of different numbers.

According to an embodiment, operation 1f-15 may be performed between operations 1f-20 and 1f-25. For reference, the Reader 1f-05 may perform transmission to the A-IoT device 1f-01 in a state of not knowing whether the message is segmented or not. The segmented message in operation 1f-10 and the segmented message in operation 1f-15 may each include at least a portion of the following.
Device identifiers capable of identifying the A-IoT device 1f-01
   The identifier may be included in a header of a message.
An information element indicating whether it is a command message or not
   The information element may be included in a header of a message.
A command type and/or command information element
   Write: an information element for recording a specific command
   Read: an information element for reading a specific command
   Activate or deactivate: an information element for activating or deactivating an A-IoT device
Segment number of segmented command message
   The segment number may indicate one of predetermined integer values. For example, the segment number may be represented as a natural number value between 0 and X. Here, 0 may represent the segment number of a first segmented command message, 1 may represent the segment number of a second segmented command message, and X may represent the segment number of an (X+1)^{th} segmented command message.
   The segment number may be included in a header of the message.
Information indicating that a segmented command message is a last message or not
   In case that a current segmented command message is a last message, 1 or lastSegment may be included, and otherwise, 0 or notLastSegment may be included. Alternatively, in case that the current segmented command message is the last, information (e.g., one bit) indicating that the segmented command message is the last may be included and otherwise, no information may be included.
   The information may be included in a header of a message.
Number of segments indicating the number of segmented command messages
   This is the number of segments indicating the number of segmented command messages that need to be combined into one, and in case that a value of 2 is included, it may indicate that two segmented command messages need to be combined into one.
   The number of segments may be included in a header of a message.

According to an embodiment, in operation 1f-20, the Reader 1f-05 may broadcast/transmit the segmented command message received in operation 1f-10 to the A-IoT device 1f-01. An access stratum (AS) layer of an A-IoT device having received the segmented command message may transfer the command message to a higher layer device of the A-IoT device. That is, the AS layer of the A-IoT device may not know whether the command message is segmented.

The higher layer device of the A-IoT device having received the command message from the AS layer of the A-IoT device may determine that the segmented command message is a first segmented message (e.g., the segment number is 0), and in this case, may store the segmented command message. The higher layer device of the A-IoT device may set or use or apply the segment number as a current value (of course, it's possible to want to continuously receive segmented command messages).

According to an embodiment, in operation 1f-25, the Reader 1f-01 may broadcast/transmit the segmented command message received in operation 1f-15 to the A-IoT device 1f-01. The AS layer of the A-IoT device having received the command message may transfer the command message to the higher layer device of the A-IoT device. In case that the segment number included in the command message is greater than 1 (i.e., the segment number of the message received in operation 1f-25=the segment number of the message received in operation 1f-20+1), the command message may be stored. In case that all segmented command messages are received, all segmented command messages may be assembled (or combined).

According to an embodiment, in operation 1f-30, the A-IoT device 1f-01 may perform a command operation based on assembling all the segmented command messages and transmit a command response message including information about the command operation to the Reader 1f-05. The Reader 1f-05 may forward (1f-35) the received response message to the CN 1f-08. For example, in case that segmentation is required when the A-IoT device transmits the command response message to the Reader, the segmented command response message may include at least a portion of the following information. Two or more segmented messages may be transmitted to the Reader.
A segment number of a segmented command response message
   The segment number may indicate one of predetermined integer values. For example, the segment number may be represented as a natural number value between 0 and X. Here, 0 may represent the segment number of a first segmented command response message, 1 may represent the segment number of a second segmented command response message, and X may represent the segment number of an (X+1)th segmented command response message.
   The segment number may be included in a header of a message.
Information indicating that a segmented command response message is a last message or not
   In case that a current segmented command response message is a last message, 1 or lastSegment may be included, and otherwise, 0 or notLastSegment may be included. Alternatively, in case that the current segmented command response message is the last, information (e.g., one bit) indicating that the segmented command message is the last may be included and otherwise, no information may be included.
   The information may be included in a header of a message.
Number of segments indicating the number of segmented command response messages
   This is the number of segments indicating the number of segmented command response messages that need to be combined into one, and in case that a value of 2 is included, it may indicate that two segmented command response messages need to be combined into one.
   The number of segments may be included in a header of a message.

FIG. 1G is a flowchart illustrating an Ambient IoT device receiving a segmented command message and responding thereto according to an embodiment of the disclosure.

In the disclosure, the core network 1g-08 may perform the command procedure with a specific Ambient IoT (A-IoT) device having successfully performed the inventory procedure according to the embodiment described above. The core network may transmit a segmented command message that is segmented according to a capability of the A-IoT device through the Reader 1g-05. For example, in case that a size of the information to be provided through the command message is larger than a size of the information that may be included in a single command message, the core network 1g-08 may segment the information to be provided through the command message into a plurality of command messages and transmit the plurality of segmented command messages to the A-IoT device through the Reader 1g-05.

Referring to FIG. 1G, according to the embodiment described above, a predetermined Ambient IoT (A-IoT) device 1g-01 may correspond to a device having successfully performed the inventory procedure.

According to an embodiment, in operations 1g-10 and 1g-15, the core network (hereinafter, CN 1g-08) may transmit a plurality of segmented command messages (segment of command message) to the Reader 1g-05 to transmit and/or receive data (e.g., Ambient IoT data) to and/or from the A-IoT device 1g-01. For ease of illustration, two segmented command messages are assumed in this disclosure, this is merely an example, and the disclosure is not limited thereto. Operation 1g-15 may be performed between operations 1g-20 and 1g-25. For reference, the Reader 1g-05 may perform transmission to the A-IoT device 1g-01 without knowing whether the command message is segmented or not. However, this is merely an example, and the Reader 1g-05 may perform transmission to the A-IoT device 1g-01 in a state of knowing whether the command message is segmented or not.

According to an embodiment, the segmented command message in operation 1g-10 and the segmented command message in operation 1g-15 may each include at least one of the following.
Device identifiers capable of identifying the A-IoT device 1g-01
   The identifier may be included in a header of a command message.
An information element indicating whether it is a command message or not
   The information element may be included in a header of a command message.
A command type and/or command information element
   Write: an information element for recording a specific command
   Read: an information element for reading a specific command
   Activate or deactivate: an information element for activating or deactivating an A-IoT device
Segment number of segmented command message
   The segment number may indicate one of predetermined integer values. For example, the segment number may be represented as a natural number value between 0 and X. Here, 0 may represent the segment number of a first segmented command message, 1 may represent the segment number of a second segmented command message, and X may represent the segment number of an (X+1)th segmented command message.
   The segment number may be included in a header of a command message.
Information indicating that a segmented command message is a last message or not
   In case that a current segmented command message is a last message, 1 or lastSegment may be included, and otherwise, 0 or notLastSegment may be included. Alternatively, in case that the current segmented command message is the last, information (e.g., one bit) indicating that the current segmented command message is the last may be included and otherwise, no information may be included.
   The information indicating that a command message is the last may be included in a header of the command message.
Number of segments indicating the number of segmented command messages
   This is the number of segments indicating the number of segmented command messages that need to be combined into one, and in case that a value of 2 is included, it may indicate that two segmented command messages need to be combined into one.
   The number of segments may be included in a header of a command message.

According to an embodiment, in operation 1g-20, the Reader 1g-05 may broadcast/transmit the segmented command messages received in operation 1g-10 to the A-IoT device 1g-01. An AS layer of the A-IoT device having received the command messages may transfer the command messages to a higher layer device of the A-IoT device. That is, the AS layer of the A-IoT device may not know whether a command message is segmented. The higher layer of the A-IoT device having received the command message from the AS layer of the A-IoT device may store the command message. The segment number included in the command message may be set or used or applied as a current value. For example, the higher layer device of the A-IoT device may identify the order of the command message based on the segment number and perform following operations (e.g., identifying that a next command message will be received) based on the segment number of the command message.

According to an embodiment, in operation 1g-25, the Reader 1g-01 may broadcast/transmit the segmented command message received in operation 1g-15 to the A-IoT device 1g-01. The AS layer of the A-IoT device having received the command message may transfer the command message to the higher layer device of the A-IoT device. In case that the higher layer device of the A-IoT device does not receive the segmented command message in operation 1g-20 and receives the segmented command message in operation 1g-25 (e.g., in case of not receiving the segmented command message having a segment number of 0 and receiving the segmented command message having a segment number of 1, or in case that a current received segment number≠a current value+1) or does not receive the segmented command message in operation 1g-25, the higher layer of the A-IoT device according to the disclosure may perform at least one of following operations.
In case that there is a stored segmented command message, the stored command message may be deleted.
A command response message including information indicating a reason why the command procedure failed and/or information indicating which segmented command message was not received, or a new response message indicating that the command procedure failed (which may also include information indicating which segmented command message was not received) may be transmitted to the AS layer of the A-IoT device. The AS layer of the A-IoT device may transmit (1g-30) same to the Reader. The Reader 1g-05 having received the command response message or the new response message may transfer (1g-35) the received message to the CN 1g-08.

For example, in case that a complete command message may not be assembled for a segmented command message during a predetermined time period, the A-IoT device 1g-01 may delete the stored segmented command messages (segments). For example, the predetermined time period may be a preconfigured time period or may be a time period configured by the core network 1g-08 and/or the Reader 1g-05. For example, the predetermined time period may be from a time point at which a first segmented command message is received or a time point at which the most recent segmented command message is received. For example, in case of receiving a command message including a command type and/or a command information element different from that of the received segmented message, the A-IoT device may delete the stored segmented command message.

For example, the Reader 1g-05 may include at least one of at least one base station or an intermediate UE (e.g., a relay UE).

FIG. 1H is a flowchart illustrating an Ambient Internet of Things (IoT) device receiving a segmented command message and responding to the command message according to an embodiment of the disclosure.

In the disclosure, according to the embodiment described above, the core network 1h-08 (e.g., an entity for the A-IoT and/or AMF) may perform the command procedure with a specific Ambient IoT (A-IoT) device having successfully performed the inventory procedure. The core network 1h-08 may transmit a command message that is segmented according to a capability of the A-IoT device through the Reader 1h-05. That is, in case that a size of the information to be provided through the command message is larger than a size of the information that may be received in a single command message, the core network 1h-08 may segment the information to be provided through the command message into a plurality of command messages and transmit the plurality of segmented command messages to the A-IoT device through the Reader 1h-05.

Referring to FIG. 1H, according to the embodiment described above, a predetermined Ambient IoT (A-IoT) device 1h-01 may correspond to a device having successfully performed the inventory procedure.

According to an embodiment, in operations 1h-10 and 1h-15, the core network (hereinafter, CN 1h-08) may transmit a plurality of segmented command messages (segment of command message) to the Reader 1h-05 to transmit and/or receive data (e.g., Ambient IoT data) to and/or from the A-IoT device 1h-01. For ease of illustration, two segmented command messages are assumed in this disclosure, this is merely an example, and command messages may be segmented by any number of different numbers (e.g., 3). For example, operation 1h-15 may be performed between operations 1h-20 and 1h-25. For example, the segmented message in operation 1h-10 and the segmented message in operation 1h-15 may each include at least one of the following.
Device identifiers capable of identifying the A-IoT device 1h-01
   The identifier may be included in a header of a command message.
An information element indicating whether it is a command message or not
   The information element may be included in a header of a command message.
A command type and/or command information element
   Write: an information element for recording a specific command
   Read: an information element for reading a specific command
   Activate or deactivate: an information element for activating or deactivating an A-IoT device
Segment number of segmented command message
   The segment number may indicate one of predetermined integer values. For example, the segment number may be represented as a natural number value between 0 and X. Here, 0 may represent the segment number of a first segmented command message, 1 may represent the segment number of a second segmented command message, and X may represent the segment number of an (X+1)th segmented command message.
   The segment number may be included in a header of a command message.
Information indicating that a segmented command message is a last message or not
   In case that a current segmented command message is a last message, 1 or lastSegment may be included, and otherwise, 0 or notLastSegment may be included. Alternatively, in case that the current segmented command message is the last, information (e.g., one bit information) indicating that the segmented command message is the last may be included and otherwise, no information may be included.
   The information indicating that a segmented command message is the last may be included in a header of the command message.
Number of segments indicating the number of segmented command messages
   This is the number of segments indicating the number of segmented command messages that need to be combined into one, and in case that a value of 2 is included, it may indicate that two segmented command messages need to be combined into one.
   The number of segments may be included in a header of a command message.

For example, a portion (e.g., segmentation information and/or an information element indicating whether it is a command message) of information included in a command message may be identified by the Reader 1h-05.

According to an embodiment, in operation 1h-20, the Reader 1h-05 may broadcast/transmit the segmented command message received in operation 1h-10 to the A-IoT device 1h-01. In case that a command message is received, the A-IoT device may perform at last one of following operations.
Operation A: An AS layer of the A-IoT, in case of determining that the received segmented command message is the very first segmented message (e.g., an initial segmented message or a first segmented message) (e.g., in case of the segment number of 0), may store the received segmented message. The AS layer of the A-IoT device may set or use or apply the segment number included in the command message as a current value.
Operation B: The AS layer of the A-IoT device may forward the received message to the higher layer of the A-IoT device. The higher layer of the A-IoT, in case of determining that the received segmented command message is the very first segmented message (e.g., in case of the segment number of 0), may store the received segmented message. The higher layer of the A-IoT device may set or use or apply the segment number included in the command message as a current value.

According to an embodiment, in operation 1h-25, the Reader 1h-01 may broadcast/transmit the segmented command message received in operation 1h-15 to the A-IoT device 1h-01. The AS layer of the A-IoT device having received the command message, in case that the segment number included in the command message is greater than 1 (e.g., the segment number of the message received in operation 1h-25=the segment number of the message received in operation 1h-20+1), may store the received segmented message. If all segmented command messages are received, the A-IoT device may perform at last one of following operations.
Operation 1: The AS layer of the A-IoT device may assemble all segmented command messages and transfer the assembled command message to the higher layer of the A-IoT device.
Operation 2: The AS layer of the A-IoT device may transfer all stored segmented command messages to the higher layer of the A-IoT device. The higher layer device of the A-IoT device may assemble all segmented command message transferred from the AS layer of the A-IoT device.

According to an embodiment, in case that a command message is received, the AS layer of the A-IoT device 1h-01 may forward the received command message to the higher layer of the A-IoT device. In addition, the higher layer of the A-IoT device 1h-01, in case that the segment number included in the command message is greater than 1 (e.g., the segment number of the message received in operation 1h-25=the segment number of the message received in operation 1h-20+1), may store the received segmented message. In case that all segmented command messages are received (this may be determined by the higher layer of the A-IoT device), the higher layer of the A-IoT device 1h-01 may assemble all received segmented command messages.

According to an embodiment, in operation 1h-30, the A-IoT device 1h-01 may perform a command operation according to assembling all the segmented command messages and transmit a command response message including information about the command operation to the Reader 1h-05. Thereafter, the Reader 1h-05 may forward (1h-35) the received response message to the CN 1h-08. For example, in case that segmentation is required when the A-IoT device 1h-01 transmits the command response message to the Reader 1h-05, the segmented command response message may include at least a portion of the following information. For example, two or more segmented command response messages may be transmitted to the Reader 1h-05.
A segment number of a segmented command response message
   The segment number may indicate one of predetermined integer values. For example, the segment number may be represented as a natural number value between 0 and X. Here, 0 may represent the segment number of a first segmented command response message, 1 may represent the segment number of a second segmented command response message, and X may represent the segment number of an (X+1)th segmented command response message.
   The segment number may be included in a header of a command response message.
Information indicating that a segmented command response message is a last message or not
   In case that a current segmented command response message is a last message, 1 or lastSegment may be included, and otherwise, 0 or notLastSegment may be included. Alternatively, in case that the current segmented command response message is the last, information (e.g., one bit information) indicating that the segmented command response message is the last may be included and otherwise, no information may be included.
   The information indicating that a segmented command response message is the last may be included in a header of the command response message.
Number of segments indicating the number of segmented command response messages
   This is the number of segments indicating the number of segmented command response messages that need to be combined into one, and in case that a value of 2 is included, it may indicate that two segmented command response messages need to be combined into one.
   The number of segments may be included in a header of a command response message.

FIG. 1I is a flowchart illustrating a method in which an Ambient IoT device receives a segmented command message and responds to the command message according to an embodiment of the disclosure.

In the disclosure, the core network 1i-08 may perform the command procedure with a specific Ambient IoT (A-IoT) device having successfully performed the inventory procedure according to the embodiment described above. The core network 1i-08 may transmit command messages that are segmented according to a capability of the A-IoT device through the Reader 1i-05. That is, in case that a size of the information to be provided through the command message is larger than a size of the information that may be received in a single command message, the core network 1i-08 may segment the information to be provided through the command message into a plurality of segmented command messages and transmit the plurality of segmented command messages to the A-IoT device through the Reader 1i-05.

Referring to FIG. 1I, according to the embodiment described above, a predetermined Ambient IoT (A-IoT) device 1i-01 may correspond to a device having successfully performed the inventory procedure.

According to an embodiment, in operations 1i-10 and 1i-15, the core network (hereinafter, CN 1i-08) may transmit a plurality of segmented command messages (segment of command message) to the Reader 1i-05 to transmit and/or receive data (e.g., Ambient IoT data) to and/or from the A-IoT device 1i-01. For ease of illustration, two segmented command messages are assumed in this disclosure, but this is merely an example. Operation 1i-15 may be performed between operations 1i-20 and 1i-25. The segmented message in operation 1i-10 and the segmented message in operation 1i-15 may each include at least one of the following.
Device identifiers capable of identifying the A-IoT device 1i-01
   The identifier may be included in a header of a command message.
An information element indicating whether it is a command message or not
   The information element may be included in a header of a command message.
A command type and/or command information element
   Write: an information element for recording a specific command
   Read: an information element for reading a specific command
   Activate or deactivate: an information element for activating or deactivating an A-IoT device
Segment number of segmented command message
   The segment number may indicate one of predetermined integer values. For example, the segment number may be represented as a natural number value between 0 and X. Here, 0 may represent the segment number of a first segmented command message, 1 may represent the segment number of a second segmented command message, and X may represent the segment number of an (X+1)th segmented command message.
   The segment number may be included in a header of a command message.
Information indicating that a segmented command message is a last message or not
   In case that a current segmented command message is a last message, 1 or lastSegment may be included, and otherwise, 0 or notLastSegment may be included. Alternatively, in case that the current segmented command message is the last, information (e.g., one bit) indicating that the segmented command message is the last may be included and otherwise, no information may be included.
   The information indicating that a command message is the last may be included in a header of the command message.
Number of segments indicating the number of segmented command messages
   This is the number of segments indicating the number of segmented command messages that need to be combined into one, and in case that a value of 2 is included, it may indicate that two segmented command messages need to be combined into one.
   The number of segments may be included in a header of a command message.

For reference, a portion (e.g., segmentation information and/or an information element indicating whether it is a command message) of information included in a command message may be identified by the Reader 1i-05.

According to an embodiment, in operation 1i-20, the Reader 1i-05 may broadcast/transmit the segmented command messages received in operation 1i-10 to the A-IoT device 1i-01. In case that the message is received, the A-IoT device 1i-01 may perform at last one of following operations.
Operation A: The AS layer of the A-IoT 1i-01, in case of determining that the received segmented command message is the very first segmented message (e.g., in case of the segment number of 0), may store the received segmented command message. Thereafter, the AS layer of the A-IoT device 1i-01 may set or use or apply the segment number included in the command message as a current value.
Operation B: The AS layer of the A-IoT device may forward the received command message to the higher layer of the A-IoT device. The higher layer of the A-IoT, in case of determining that the received segmented command message is the very first segmented message (e.g., in case of the segment number of 0), may store the received segmented message. The higher layer of the A-IoT device may set or use or apply the segment number included in the command message as a current value.

According to an embodiment, in operation 1i-25, the Reader 1i-01 may broadcast/transmit the segmented command message received in operation 1i-15 to the A-IoT device 1i-01. In case that the AS layer of the A-IoT device 1i-01 does not receive the segmented command message in operation 1i-20 and receives the segmented command message in operation 1i-25 (e.g., in case of not receiving the segmented command message having a segment number of 0 and receiving the segmented command message having a segment number of 1, or in case that a current received segment number≠a current value+1) or does not receive the segmented command message in operation 1i-25, the A-IoT device 1i-01 according to the disclosure may perform at least one of following operations.
The AS layer of the A-IoT device 1i-01 may indicate an indicator indicating that the command procedure has failed to the higher layer of the A-IoT device.
The AS layer of the A-IoT device 1i-01 may inform the higher layer of the A-IoT device of information indicating which segmented command message has not been received.
A command response message including information indicating a reason why the command procedure failed and/or information indicating which segmented command message was not received, or a new response message indicating that the command procedure failed (e.g., information indicating which segmented command message was not received may be also included) may be transmitted to the AS layer of the A-IoT device 1i-01. The AS layer of the A-IoT device 1i-01 may transmit (1i-30) a command response message and/or a new response message to the Reader 1i-05. The Reader 1i-05 having received the command response message and/or the new response message may transfer (1i-35) the received message to the CN 1i-08.
The AS layer of the A-IoT device may generate information indicating that the command procedure has failed and provide 1i-30 the information indicating that the command procedure has failed to the Reader 1i-05. The Reader 1i-05 having received the information indicating that the command procedure has failed may provide 1i-35 the received information to the CN 1i-08.
In case that there is a stored segmented command message, the stored command message may be deleted.

For reference, in case that a complete command message may not be assembled for segmented command messages during a predetermined time period, the A-IoT device 1i-01 may delete at least a portion of the stored segmented command messages (e.g., segments). For example, the predetermined time period may be a preconfigured time period or may be a time period configured by the core network 1i-08 and/or the Reader 1i-05. For example, the predetermined time period may be from a time point at which a first segmented command message is received. For example, the predetermined time period may be from a time point at which a most recent segmented command message is received. For example, in case of receiving a command message including a command type and/or a command information element different from that of the received segmented message, the A-IoT device 1i-01 may delete at least a portion of the stored segmented command messages.

FIG. 1J is a flowchart illustrating a method in which an Ambient IoT device receives a segmented command message and responds to the command message according to an embodiment of the disclosure.

In the disclosure, the core network 1j-08 may perform the command procedure with a specific Ambient IoT (A-IoT) device 1j-01 having successfully performed the inventory procedure according to the embodiment described above. The Reader 1j-05 may transmit command messages that are segmented according to a capability of the A-IoT device to the A-IoT device 1j-01. For example, the Reader 1j-05 having received one command message from the core network 1j-08, in case that a size of the received command message to be transferred to the A-IoT device 1j-01 is greater than a size of information receivable by the A-IoT device, may transfer a plurality of segmented command messages to the A-IoT device 1j-01.

Referring to FIG. 1J, according to the embodiment described above, a predetermined Ambient IoT (A-IoT) device 1j-01 may correspond to a device having successfully performed the inventory procedure.

In operation 1j-10, the core network (hereinafter, CN 1j-08) may transmit a command message to the Reader 1j-05 to transmit and/or receive Ambient IoT data to and/or from the A-IoT device 1j-01. The command message may include at least one of following.
Device identifiers capable of identifying the A-IoT device 1j-01
   The identifier may be included in a header of a command message.
An information element indicating whether it is a command message or not
   The information element may be included in a header of a command message.
A command type and/or command information element
   Write: an information element for recording a specific command
   Read: an information element for reading a specific command
   Activate or deactivate: an information element for activating or deactivating an A-IoT device

According to an embodiment, in operations 1j-20 and 1j-25, the Reader 1j-05 may segment the command message received in operation 1j-10 (e.g., the Reader may segment the command type and/or the command information element) and broadcast/transmit each of segmented command messages to the A-IoT device 1j-01. The segmented command messages may include at least one of following.
Device identifiers capable of identifying the A-IoT device 1j-01
   The identifier may be included in a header of a command message.
An information element indicating whether it is a command message or not
   The information element may be included in a header of a command message.
A command type and/or command information element
   Write: an information element for recording a specific command
   Read: an information element for reading a specific command
   Activate or deactivate: an information element for activating or deactivating an A-IoT device
Segment number of segmented command message
   The segment number may indicate one of predetermined integer values. For example, the segment number may be represented as a natural number value between 0 and X. Here, 0 may represent the segment number of a first segmented command message, 1 may represent the segment number of a second segmented command message, and X may represent the segment number of an (X+1)th segmented command message.
   The segment number may be included in a header of a command message.
Information indicating that a segmented command message is a last message or not
   In case that a current segmented command message is a last message, 1 or lastSegment may be included, and otherwise, 0 or notLastSegment may be included. Alternatively, in case that the current segmented command message is the last, information (e.g., one bit information) indicating that the segmented command message is the last may be included and otherwise, no information may be included.
   The information indicating that a segmented command message is the last may be included in a header of the command message.
Number of segments indicating the number of segmented command messages
   This is the number of segments indicating the number of segmented command messages that need to be combined into one, and in case that a value of 2 is included, it may indicate that two segmented command messages need to be combined into one.
   The number of segments may be included in a header of a command message.

Each of operations 1j-20, 1j-25, 1j-30, and 1j-35 in FIG. 1J may correspond to the operation of the A-IoT device 1i-01, the operation of the Reader 1i-05, and the operation of the core network 1i-08 with respect to operations 1i-20, 1i-25, 1i-30, 1i-35 in FIG. 1I. That is, the description for operations 1i-20, 1i-25, 1i-30, 1i-35 in FIG. 1I may be applied to operations 1j-20, 1j-25, 1j-30, and 1j-35 in FIG. 1J unless there is contradiction.

FIG. 1K illustrates an internal structure of a UE according to an embodiment of the disclosure.

Referring to FIG. 1K, the UE may include a radio frequency (RF) processor 1k-10, a baseband processor 1k-20, a storage unit 1k-30, and/or a controller 1k-40. The storage unit 1k-30 may include a memory. The controller 1k-40 may include at least one processor 1k-42. The RF processor 1k-10 and the baseband processor 1k-20 may be included in a transceiver.

The description of the UE of the disclosure in FIG. 1K may be applied to the A-IoT device and/or intermediate UE (or relay UE) (e.g., reader) in FIGS. 1A to 1J.

According to an embodiment, the RF processor 1k-10 may perform functions for transmitting/receiving signals through a radio channel, such as signal band conversion and amplification. That is, the RF processor 1k-10 may up-convert a baseband signal provided from the baseband processor 1k-20 to an RF band signal, may transmit the same through an antenna, and may down-convert an RF band signal received through the antenna to a baseband signal. For example, the RF processor 1k-10 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 1k-10 may include multiple RF chains. Furthermore, the RF processor 1k-10 may perform beamforming. For the beamforming, the RF processor 1k-10 may adjust the phase and magnitude of signals transmitted/received through multiple antennas or antenna elements, respectively. In addition, the RF processor may perform MIMO, and may receive multiple layers when performing a MIMO operation.

The baseband processor 1k-20 may perform functions of conversion between baseband signals and bitstrings according to the physical layer specifications of the system. For example, during data transmission, the baseband processor 1k-20 may encode and modulate a transmitted bitstring to generate complex symbols. In addition, during data reception, the baseband processor 1k-20 may demodulate and decode a baseband signal provided from the RF processor 1k-10 to restore a received bitstring. For example, when following the orthogonal frequency division multiplexing (OFDM) scheme, during data transmission, the baseband processor 1k-20 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 1k-20 may split a baseband signal provided from the RF processor 1k-10 at the OFDM symbol level, may restore signals mapped to subcarriers through a fast Fourier transform (FFT) operation, and may restore a received bitstring through demodulation and decoding.

The baseband processor 1k-20 and the RF processor 1k-10 may transmit and receive signals as described above. Therefore, the baseband processor 1k-20 and the RF processor 1k-10 may be referred to as a transmitter, a receiver, a transceiver, or a communication unit. Furthermore, at least one of the baseband processor 1k-20 and the RF processor 1k-10 may include multiple communication modules to support multiple different radio access technologies. In addition, at least one of the baseband processor 1k-20 and the RF processor 1k-10 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands.

According to an embodiment, the storage unit 1k-30 may store data such as a basic program, an application program, and configuration information for an operation of the UE. Particularly, the storage unit 1k-30 may store information on a second access node configured to perform wireless communication by using a second radio access technology. In addition, the storage unit 1k-30 may provide the stored data at the request of the controller 1k-40.

The controller 1k-40 controls the overall operation of the UE. For example, the controller 1k-40 may transmit/receive signals through the baseband processor 1k-20 and the RF processor 1k-10. In addition, the controller 1k-40 records data in the storage unit 1k-30 and reads the data from the storage unit 1k-30. To this end, the controller 1k-40 may include at least one processor. For example, the controller 1k-40 may include a communication processor (CP) configured to perform control for communication, and an application processor (AP) configured to control upper layers such as application programs.

FIG. 1L is a block diagram illustrating a structure of an NR base station according to an embodiment of the disclosure.

Referring to FIG. 1L, the base station may include an RF processor 1l-10, a baseband processor 1l-20, a backhaul communicator 1l-30, a storage 1l-40, and a controller 1l-50. The storage unit 1l-40 may include a memory. The controller 1l-50 may include at least one processor 1l-52. The RF processor 1l-10 and the baseband processor 1l-20 may be included in a transceiver.

The description of the base station of the disclosure in FIG. 1L may be applied to the base station (e.g., reader) in FIGS. 1A to 1J.

According to an embodiment, the RF processor 1l-10 may perform a function, such as signal band conversion, amplification, etc., for transmitting or receiving a signal through a wireless channel. That is, the RF processing unit 1l-10 up-converts a baseband signal provided from the baseband processor unit 1l-20 to an RF band signal, transmits the same through an antenna, and down-converts an RF band signal received through the antenna to a baseband signal. For example, the RF processor 1l-10 may include a transmission filter, a reception filter, an amplifier, a mixer, an oscillator, a DAC, and an ADC. Although only one antenna is illustrated in the drawing, the first access node may include multiple antennas. In addition, the RF processor 1l-10 may include multiple RF chains. Furthermore, the RF processor 1l-10 may perform beamforming. For the beamforming, the RF processor 1l-10 may adjust the phase and magnitude of signals transmitted/received through multiple antennas or antenna elements, respectively. The RF processor may transmit one or more layers to perform a downward MIMO operation.

According to an embodiment, the baseband processor 1l-20 may perform a function of conversion between a baseband signal and a bitstream according to a physical layer specification of a first wireless access technology. For example, during data transmission, the baseband processor 1l-20 may encode and modulate a transmitted bitstring to generate complex symbols. In addition, during data reception, the baseband processor 1l-20 may demodulate and decode a baseband signal provided from the RF processor 1l-10 to restore a received bitstring. For example, when following the OFDM scheme, during data transmission, the baseband processor 1l-20 may encode and modulate a transmitted bitstring to generate complex symbols, may map the complex symbols to subcarriers, and may configure OFDM symbols through IFFT operation and CP insertion. In addition, during data reception, the baseband processor 1l-20 may split a baseband signal provided from the RF processor 1l-10 at the OFDM symbol level, may restore signals mapped to subcarriers through FFT operation, and may restore a received bitstring through demodulation and decoding. The baseband processor 1l-20 and the RF processor 1l-10 may transmit and receive signals as described above. Therefore, the baseband processor 1l-20 and the RF processor 1l-10 may be referred to as a transmitter, a receiver, a transceiver, or a communication unit.

According to an embodiment, the backhaul communication unit 1l-30 may provide an interface for performing communication with other nodes within a network. That is, the backhaul communication unit 1l-30 converts bitstrings transmitted from the main base station to other nodes, for example, an auxiliary base station, a core network, etc., into physical signals, and converts physical signals received from the other nodes into bitstrings.

According to an embodiment, the storage unit 1l-40 may store data such as a basic program, an application program, and configuration information for operations of the base station. Particularly, the storage unit 1l-40 may store information on a bearer allocated to a connected UE, a measurement result reported from the connected UE, and the like. In addition, the storage unit 1l-40 may store information serving as a reference to determine whether to provide multi-connection to a UE or to suspend the same. In addition, the storage unit 1l-40 may provide the stored data at the request of the controller 1l-50.

According to an embodiment, the controller 1l-50 may control the overall operation of the main base station. For example, the controller 1l-50 may transmit/receive signals through the baseband processor 1l-20 and the RF processor 1l-10 or through the backhaul communication unit 1l-30. In addition, the controller 1l-50 records data in the storage unit 1l-40 and reads the data from the storage unit 1l-40. To this end, the controller 1l-50 may include at least one processor.

FIG. 1M illustrates a structure of a network entity according to an embodiment of the disclosure. A structure of a core network entity in a wireless communication system according to various embodiments of the disclosure is illustrated.

The structure illustrated in FIG. 1M may be understood as corresponding to at least one of the network entities (e.g., AMF) in FIGS. 1A to 1J. As used herein, the term “ . . . unit”, “-er”, or the like refers to a unit configured to process at least one function or operation, and may be implemented as hardware, software, or a combination of hardware and software.

Referring to FIG. 1M, the core network entity may include a communication unit 1m-40, a storage unit 1m-45, and a controller 1m-50.

The communication unit 1m-40 provides an interface for communicating with other devices in the network. That is, the communication unit 1m-40 converts a bitstring, transmitted from the core network entity to any other device, into a physical signal, and converts a physical signal, received from any other device, into a bitstring. The communication unit 1m-40 may transmit/receive signals. Accordingly, the communication unit 1m-40 may be referred to as a modem, a transmitter, a receiver, or a transceiver. The communication unit 1m-40 enables the core network entity to communicate with other devices or the system via a backhaul connection (e.g., wired backhaul or wireless backhaul) or via a network.

The storage unit 1m-45 stores data such as basic programs, application programs, and configuration information for operations of the core network entity. The storage unit 1m-45 may be configured by a volatile memory, a nonvolatile memory, or a combination of a volatile memory and a nonvolatile memory. In addition, the storage unit 1m-45 provides the stored data at the request of the controller 1m-50.

The controller 1m-50 controls the overall operation of the core network entity. For example, the controller 1m-50 transmits/receives signals through the communication unit 1m-40. In addition, the controller 1m-50 records data in the storage unit 1m-45 and reads the data from the storage 1m-45. The controller 1m-50 may include at least one processor. According to various embodiments, the controller 1m-50 may control to perform synchronization by using a wireless communication network. For example, the controller 1m-50 may control the core network entity to perform operations according to various embodiments described below.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an ambient internet of things (IoT) (A-IoT) device in a wireless communication system, the method comprising:
receiving, from a reader, a command message; and
transmitting, to the reader, at least one of segments of a command response message,
wherein each of the at least one of the segments includes information indicating whether a segment including the information is a last segment or not.

2. The method of claim 1,
wherein the information includes a 1-bit indicator indicating whether the segment is the last segment or not,
wherein, in case that the information is set to a first value, the segment is the last segment, and
wherein, in case that the information is set to a second value, the segment is not the last segment.

3. The method of claim 1, further comprising:
performing an operation based on the command message,
wherein the operation includes at least one of writing a command of the command message, reading the command, activating the A-IoT device, or deactivating the A-IoT device.

4. The method of claim 1, further comprising:
receiving, from the reader, a message for a random access procedure; and
transmitting, to the reader, a random access preamble for the random access procedure based on the message.

5. The method of claim 1, wherein, in case that the information is included in the segment, the segment is the last segment.

6. A method performed by a reader in a wireless communication system, the method comprising:
transmitting, to an ambient internet of things (IoT) (A-IoT) device, a command message; and
receiving, from the A-IoT device, at least one of segments of a command response message,
wherein each of the at least one of the segments includes information indicating whether a segment including the information is a last segment or not.

7. The method of claim 6,
wherein the information includes a 1-bit indicator indicating whether the segment is the last segment or not,
wherein, in case that the information is set to a first value, the segment is the last segment, and
wherein, in case that the information is set to a second value, the segment is not the last segment.

8. The method of claim 6,
wherein an operation of the A-IoT device is based on the command message, and
wherein the operation includes at least one of writing a command of the command message, reading the command, activating the A-IoT device, or deactivating the A-IoT device.

9. The method of claim 6, further comprising:
transmitting, to the A-IoT device, a message for a random access procedure; and
receiving, from the A-IoT device, a random access preamble for the random access procedure based on the message.

10. The method of claim 6, wherein, in case that the information is included in the segment, the segment is the last segment.

11. An ambient internet of things (IoT) (A-IoT) device in a wireless communication system, the A-IoT device comprising:
a transceiver; and
a controller coupled with the transceiver and configured to:
receive, from a reader, a command message, and
transmit, to the reader, at least one of segments of a command response message,
wherein each of the at least one of the segments includes information indicating whether a segment including the information is a last segment or not.

12. The A-IoT device of claim 11,
wherein the information includes a 1-bit indicator indicating whether the segment is the last segment or not,
wherein, in case that the information is set to a first value, the segment is the last segment, and
wherein, in case that the information is set to a second value, the segment is not the last segment.

13. The A-IoT device of claim 11,
wherein the controller is further configured to:
perform an operation based on the command message, and
wherein the operation includes at least one of writing a command of the command message, reading the command, activating the A-IoT device, or deactivating the A-IoT device.

14. The A-IoT device of claim 11, wherein the controller is further configured to:
receive, from the reader, a message for a random access procedure; and
transmit, to the reader, a random access preamble for the random access procedure based on the message.

15. The A-IoT device of claim 11, wherein, in case that the information is included in the segment, the segment is the last segment.

16. A reader in a wireless communication system, the reader comprising:
a transceiver; and
a controller coupled with the transceiver and configured to:
transmit, to an ambient internet of things (IoT) (A-IoT) device, a command message, and
receive, from the A-IoT device, at least one of segments of a command response message,
wherein each of the at least one of the segments includes information indicating whether a segment including the information is a last segment or not.

17. The reader of claim 16,
wherein the information includes a 1-bit indicator indicating whether the segment is the last segment or not,
wherein, in case that the information is set to a first value, the segment is the last segment, and
wherein, in case that the information is set to a second value, the segment is not the last segment.

18. The reader of claim 16,
wherein an operation of the A-IoT device is based on the command message, and
wherein the operation includes at least one of writing a command of the command message, reading the command, activating the A-IoT device, or deactivating the A-IoT device.

19. The reader of claim 16, wherein the controller is further configured to:
transmit, to the A-IoT device, a message for a random access procedure, and
receive, from the A-IoT device, a random access preamble for the random access procedure based on the message.

20. The reader of claim 16, wherein, in case that the information is included in the segment, the segment is the last segment.
